(19) United States
(12) Patent Application Publication
(10) Pub. No.: US 2007/0051570 A1
(43) Pub. Date: Mar. 8, 2007

(54) Brake spider

(76) Inventor: Bruce Wayne Hendrickson, Zwolle, LA (US)

Correspondence Address: Richard Bray Williams, P.O. Box 15, Natchitoches, LA, 71458-0015, US

(21) Appl. No.: 11/210,711

(22) Filed: Aug. 23, 2005

(51) Int. Cl. F16D 65/10

(52) U.S. Cl. 188/218 R; 188/234

(57) ABSTRACT

A brake spider provides the foundation for brake assemblies and supports the various components of brake assemblies. The brake spider, typically made of forged weldable steel and/or iron alloys, is permanently attached to and immobilized on an axle, usually by welding. The brake spider contains three different apertures, the brake shoe anchor pin(s) aperture(s), the axle aperture, and the brake actuator means aperture. The brake actuator means aperture is split to allow access to the brake actuator without the need to remove the brake hub.

### BACKGROUND

The present invention relates to brake assemblies, more specifically the brake spider which provides the main source of support an internally expanding drum brake assembly used in vehicles and tractor-trailers with air brake systems.

As society grows, the need for transportation of goods increases. A major form of goods transportation occurs over the innumerable roads, state highways and interstate highways by way of heavy-duty tractor-trailers. The cost of operating and maintaining a tractor-trailer is a major cause of concern for the owners and operators of the tractor-trailer.

An increase in the cost of operating and maintaining a tractor-trailer is eventually passed along to the consumer through an increase in the price of the good being transported. Major factors contributing to the increase in the cost of operating and maintaining a tractor-trailer are the replacement costs of worn brake components and the lost productivity of the tractor-trailer while the brakes are being serviced. The time devoted to replacing certain bushings in the brake assembly increases significantly the lost productivity of the tractor-trailer while the brakes are being serviced.

The brake spider is well known in the prior art as the foundation of brake assemblies and supports the various components of brake assemblies, such as U.S. Pat. No. 2,965,199 to Van Raden. The brake spider is typically made of forged weldable steel and/or iron alloys. The brake spider is then typically either welded onto the trailer axle and remains immobile or a brake spider support plate is welded onto the trailer and the brake spider is bolted to the brake spider support plate. The various components of the brake assembly are then fixed to the brake spider through its remaining apertures.

The brake spider has generally three apertures that exist horizontally along its axis, the brake shoe anchor pin(s) aperture(s), the axle aperture (the central aperture) and the brake actuator means aperture, axially separated on the brake spider from the brake shoe pin(s) aperture(s).

A rotating brake hub secures the rotating brake drum to the axle and the rotating wheels are bolted to both the brake hub and brake drum . The brake actuator means operates to selectively spread the brake shoes until they contact the inside surface of the rotating brake drum. The brake actuator means is typically a cam that is attached to a cylindrical camshaft with the cam usually taking a s-like shape, the entire structure is commonly known as the s-cam. Cam actuated and s-cam actuated brake systems are well known in the prior art, cam actuated seen by U.S. Pat. Nos. 2,002,139 and 3,096,857; and s-cam actuated seen by U.S. Pat. Nos. 3,497,037 and 4,552,254.

The s-cam passes through the brake spider at the actuator means aperture and is supported in the actuator means aperture by a bushing, commonly known as the s-cam bushing. The s-cam bushing will deteriorate over time and needs replacing. The s-cam bushing, if not replaced timely, can lead to uneven brake shoe wear and even damage the shaft of the s-cam, requiring replacing of the s-cam. Replacing the s-cam bushings and/or the s-cam is a labor intensive and time-consuming task that increases the operating and maintenance costs of the brake assembly. The large amount of labor time involved in replacing the s-cam bushing is mainly due to having to remove and eventual reassembly of the brake hub in order to access the s-cam bushing.

Thus there is a need for a brake spider that allows for a rapid replacement of the s-cam bushing without the need to remove the rotating brake hub and thereby help reduce the cost of operating and maintaining the tractor-trailer and help reduce the lost productivity of the tractor-trailer.

### SUMMARY

The present invention meets this need by providing a brake spider that allows for the rapid replacement of the s-cam bushing without having to remove the rotating wheel and brake drum, comprising: a brake spider that has a spider body having an aperture that attaches the spider body to an axle housing and an aperture for an anchor pin to pivotally attach brake shoes to the spider body that is axially separated from an aperture for an actuating means to spread the brake shoes apart to frictionally contact a rotating brake drum, and the actuating means aperture that is split from the spider body and a selectively removable attachment means securing the actuating means aperture and the spider body.

In some embodiments the actuating means aperture is split into two halves of unequal size with the larger half consisting of the spider body with the anchor pin aperture, the axle housing aperture and the non-detachable portion of the actuating means aperture, with the split occurring latitudinally along the diameter of the actuating means aperture. The smaller second half of the actuating means aperture being the detachable portion of the actuating means aperture. The two halves, the spider body and the detachable portion of the actuating means aperture, are joined by a selectively removable attachment means such at least one bolt and nut and the like.

### DRAWINGS

These and other features, aspects, and advantages of the present invention will become better understood with regard to the following description, appended claims, and the accompanying drawings, where:

FIG. 1 shows a sectional side elevation view of the axle spindle and brake spider with the modified actuating means aperture, without showing the brake hub, embodying features of the present invention.

FIG. 2 shows a front elevation view of the expanding shoe brake drum embodying features of the present invention.

FIG. 3 shows a side elevation view in isolation of a brake spider with the two halves of the actuating means aperture embodying features of the present invention.

### DESCRIPTION

The present invention is directed to a brake spider (10) for an internally expanding drum brake assembly (12) for vehicles and tractor-trailers. The brake spider (10) is supported by an axle (14) with the axle (14) passing through the axle aperture (16) and the brake spider (10) is rigidly fixed to the axle (14) typically by welding (18). The weld (18) is applied on both sides of the brake spider (10) and preferably extends continuously therearound.

The brake assembly (12) includes a pair of brake shoes (20) each of which is pivotally mounted at one end of the brake spider (10) to an anchor pin or anchor pins (22) that pass through the anchor pin aperture (24). On the end opposite the anchor pin aperture (24) is the actuating means aperture (26) through which passes the brake actuator cam shaft (28).

The s-cam (30) is attached to the brake actuator cam shaft (28). The s-cam (30) contacts a roller body (32) that has revolving movement, as a cam follower, on the brake actuator cam shaft (28), for forcing the outer surface (34) of the brake shoe (20) against the associated rotating brake drum's inner surface (36) to achieve the braking action of the brake assembly (12).

The expansion of the brake shoe (20) against the brake drum's inner surface (36) is shown as forced by rotation of the s-cam (30) on the brake actuator cam shaft (28), each opposite arm (30a) and (30b) having an outwardly spiraling nature and form, and each cam arm (30a) and (30b) pressing outwardly against a respective cam follower roller body (32). An actuating lever mechanism (38) extending radially from the brake actuator cam shaft (28) and connected to an air-operated mechanism (40) of an air-brake system.

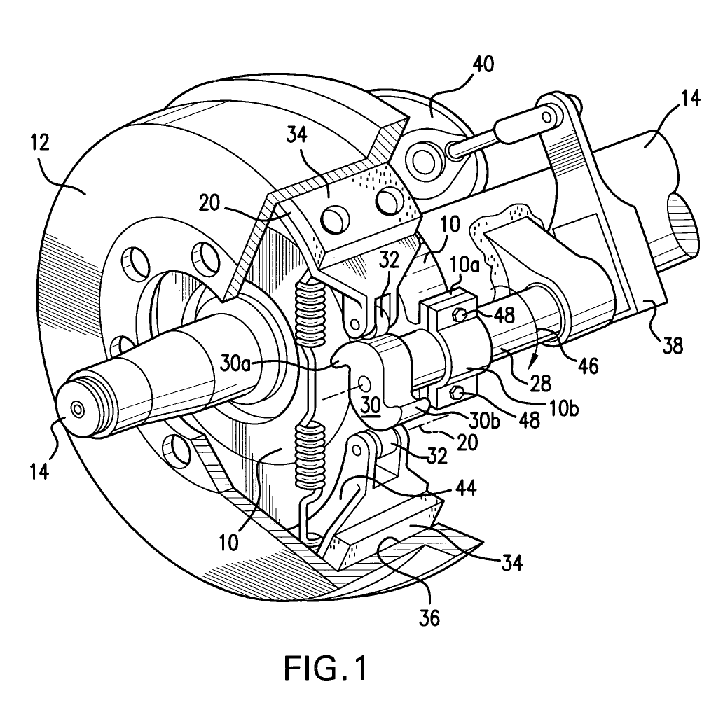

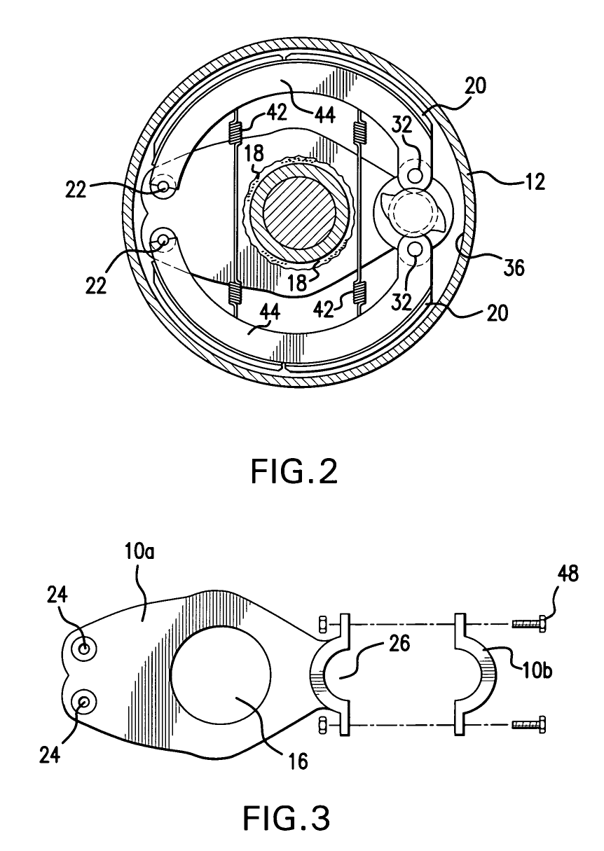

Return springs (42) are connected between the brake shoe flanges (44) which maintains each of their cam follower roller bodies (32) in a seated contact upon the surface of the s-cam (30). When the air-operated mechanism (40) is energized, the actuating lever mechanism (38) rotates the brake actuator cam shaft (28) in a clockwise direction (46), as shown in FIG. 1, and the s-cam (30) rocks the brake shoes (20) outwardly together against the rotating brake drum's inner surface (36) to achieve the braking action of the brake assembly (12).

The brake spider (10) is split at the actuating means aperture (26) creating a brake spider (10) of two unequal sized halves (10a) and (10b), as shown in FIG. 3, to give access to the s-cam (30) and the brake actuator cam shaft (28). The larger half (10a) of the brake spider (10) comprising the anchor pin apertures (24), the axle aperture (16), and a portion of the actuating means aperture (26). The smaller half (10b) of the brake spider (10) comprising the remaining section of the actuating means aperture (26).

The two halves (10a) and (10b) are joined by a selectively removable attachment means (48). In the embodiments shown in FIGS. 1 and 3, the selectively removable attachment means (48) being two nuts and bolts. The two halves (10a) and (10b) are split latitudinally along the diameter of the actuating means aperture (26), as shown in FIG. 3.

Although the present invention has been described in considerable detail with reference to certain preferred versions thereof, other versions are possible. Therefore, the spirit and scope of the appended claims should not necessarily be limited to the description of the preferred versions contained herein.

An element in a claim that does not explicitly state “means” for performing a specified function or “step” for performing a specified function, should not be interpreted as a “means” for “step” clause as specified in 35 U.S.C. § 112.

What is claimed is:

1. A brake spider to be mounted on a vehicle or tractor-trailer comprising:
A spider body having an axle housing aperture that attaches the spider body to the axle, an anchor pin aperture to pivotally attach a brake shoe to the spider body and an actuating means aperture that is axially separated from the anchor pin aperture, the actuating means aperture used to spread the brake shoes apart to frictionally contact a rotating brake drum, and
the actuating means aperture that is split from the spider body and a selectively removable attachment means securing the split actuating means aperture and the spider body.

2. The brake spider of claim 1 wherein the actuating means aperture is split into two halves of unequal size with the larger half consisting of the spider body with the anchor pin aperture, the axle house aperture and the nondetachable portion of the actuating means aperture and the second half of the brake spider being the detachable actuating means aperture.

3. The brake spider of claim 1 wherein the actuating means aperture is split latitudinally along the diameter of the actuating means aperture.

4. The brake spider of claim 1 wherein the selectively removable attachment means securing the detachable actuating means aperture comprises at least one grade eight bolt and nut.

5. The brake spider of claim 1 wherein the selectively removable attachment means securing the detachable actuating means aperture comprises at least two grade eight bolts and nuts.

6. The brake spider of claim 1 wherein the brake shoes are pivotally attached by two anchor pins.

7. The brake spider of claim 2 wherein the actuating means aperture is split latitudinally along the diameter of the actuating means aperture.

8. The brake spider of claim 2 wherein the selectively removable attachment means securing the detachable actuating means aperture comprises at least one grade eight bolt and nut.

9. The brake spider of claim 2 wherein the selectively removable attachment means securing the detachable actuating means aperture comprises at least two grade eight bolts and nuts.

10. The brake spider of claim 2 wherein the brake shoes are pivotably attached by two anchor pins.

11. The brake spider of claim 5 wherein the two grade eight bolts and nuts are located one grade eight bolt and nut above the actuating means aperture and the grade eight other bolt and nut below the actuating means aperture selectively attaching the detachable portion of the actuating means aperture to the spider body.

12. The brake spider of claim 8 wherein the two grade eight bolts and nuts are located one grade eight bolt and nut above the actuating means aperture and the grade eight other bolt and nut below the actuating means aperture selectively attaching the detachable portion of actuating means aperture to the spider body.
